(19) United States
(12) Patent Application Publication
(10) Pub. No.: US 2025/0279549 A1
(43) Pub. Date: Sep. 4, 2025

(54) TERMINAL CAP ASSEMBLY AND BATTERY MODULE INCLUDING TERMINAL CAP ASSEMBLY

(71) Applicant: SK On Co., Ltd., Seoul (KR)

(72) Inventors: Yu Taek LIM, Daejeon (KR); Do Youn KIM, Daejeon (KR); Jeong Joo LEE, Daejeon (KR); Ho Seong JANG, Daejeon (KR); Ha Chul JEONG, Daejeon (KR)

(21) Appl. No.: 19/017,779

(22) Filed: Jan. 13, 2025

(30) Foreign Application Priority Data
Mar. 4, 2024 (KR) 10-2024-0030520

(51) Int. Cl. H01M 50/503; H01M 50/583

(52) U.S. Cl. CPC H01M 50/503; H01M 50/583

(57) ABSTRACT

A battery module includes a plurality of sub-modules including a first sub-module and a second sub-module respectively including a plurality of battery cells, a first terminal portion electrically connected to the plurality of battery cells of the first sub-module and including one or more electrode terminals including a first electrode terminal, a second terminal portion electrically connected to the plurality of battery cells of the second module and including one or more electrode terminals including a first electrode terminal, and a terminal cap assembly covering the first terminal portion and the second terminal portion and electrically connecting the first terminal portion and the second terminal portion to each other. The terminal cap assembly includes a fuse wire and a protector covering the fuse wire, the first electrode terminal of the first terminal, and the first electrode terminal of the second terminal.

### CROSS-REFERENCE TO RELATED APPLICATION(S)

This patent document claims the priority and benefits of Korean Patent Application No. 10-2024-0030520 filed on Mar. 4, 2024, the disclosure of which is incorporated herein by reference in its entirety.

### TECHNICAL FIELD

The disclosure and implementations disclosed in this patent document generally relate to a terminal cap assembly and a battery module including the same.

### BACKGROUND

Secondary unlike primary batteries, are convenient, in that the secondary batteries can be charged and discharged, and thus have drawn much attention as power sources for various mobile devices and electric vehicles.

Such a secondary battery may include a battery cell. An electrode assembly, formed by stacking a cathode plate, an anode plate, and a separator or winding the cathode plate, the anode plate, and the separator in the form of a roll, may be accommodated in a case of the battery cell. A plurality of battery cells may be stacked in a predetermined direction and accommodated in a battery module or a battery pack.

Such a battery module or battery pack may have a risk of thermal runaway due to factors such as the occurrence of a short-circuit or overcurrent. Accordingly, there is a need for research into a structure for protecting a battery module or a battery pack from factors such as the occurrence of a short-circuit or overcurrent.

### SUMMARY

A terminal cap assembly and a battery module including the same of the present disclosure may prevent a short-circuit of the battery module and cut off an electrical connection between a plurality of sub-modules when an overcurrent occurs, thereby ensuring safety of the battery module.

The terminal cap assembly and the battery module including the same of the present disclosure may be fixed to terminals of two adjacent sub-modules to fix the two adjacent sub-modules.

The terminal cap assembly and the battery module including the same of the present disclosure may minimize the influence of various environmental factors that may hinder safety during transportation, thereby improving safety.

The battery module of the present disclosure may be widely applied in the field of green technology, such as to electric vehicles, battery charging stations, and other battery-utilizing solar power generation schemes, wind power generation schemes, or the like. In addition, the battery module including a pad assembly of the present disclosure may be used in eco-friendly electric vehicles, hybrid vehicles, or the like, to prevent climate change by suppressing air pollution and greenhouse gas emissions.

According to an aspect of the present disclosure, there is provided a battery module including a plurality of sub-modules including a first sub-module and a second sub-module respectively including a plurality of battery cells, a first terminal portion electrically connected to the plurality of battery cells of the first sub-module, the first terminal portion including one or more electrode terminals including a first electrode terminal, a second terminal portion electrically connected to the plurality of battery cells of the second module, the second terminal portion including one or more electrode terminals including a first electrode terminal, and a terminal cap assembly covering the first terminal portion and the second terminal portion, the terminal cap assembly electrically connecting the first terminal portion and the second terminal portion to each other. The terminal cap assembly may include a fuse wire electrically connecting the first electrode terminal of the first terminal and the first electrode terminal of the second terminal to each other, and a protector covering the fuse wire, the first electrode terminal of the first terminal, and the first electrode terminal of the second terminal.

The plurality of battery cells may be stacked in a first direction. The battery module may further include a cap cover covering the electrode terminal that is not covered by the terminal cap assembly.

The first terminal portion may further include a second electrode terminal spaced apart from the first electrode terminal of the first terminal portion in the first direction, and the second terminal portion may further include a second electrode terminal spaced apart from the first electrode terminal of the second terminal portion in the first direction. The cap cover may independently cover the second electrode terminal of the first terminal portion and the second electrode terminal of the second terminal portion.

The first electrode terminal of the first terminal portion and the second electrode terminal of the second terminal portion may have different electrical polarities. A terminal cap assembly may be disposed at one sides of the plurality of sub-modules in the first direction, and a cap cover may be disposed at the other sides of the plurality of sub-modules in the first direction.

The terminal cap assembly may be provided as one terminal cap assembly and connected to the first electrode terminal of the first terminal portion and the second electrode terminal of the second terminal portion. The terminal cap may be provided as two terminal caps, and the two terminal caps may be disposed on the second electrode terminal of the first terminal portion and the second electrode terminal of the second terminal portion, respectively.

The fuse wire may be provided to fracture due to a current having a predetermined value or more, and to cut off an electrical connection between the first terminal portion and the second terminal portion.

The fuse wire may have a diameter of 0.25 mm² to 1 mm².

The protector may include a first terminal cover covering the first electrode terminal of the first terminal portion, a second terminal cover covering the first electrode terminal of the second terminal portion, and a connection cover connecting the first terminal cover and the second terminal cover to each other.

The electrode terminal of the first terminal portion and the electrode terminal of the second terminal portion may have terminal holes, respectively. The first terminal cover and the second terminal cover may include a first protruding body and a second protruding body protruding to be inserted into the terminal holes, respectively.

The fuse wire may include a first connection portion and a second connection portion in contact with and electrically connected to the first electrode terminal of the first terminal portion and the first electrode terminal of the second terminal portion, respectively. The first protruding body and the second protruding body may pass through the first connection portion and the second connection portion, and may be inserted into the first electrode terminal of the first terminal portion and the first electrode terminal of the second terminal portion, respectively.

The protector may include a first seating body and a second seating body respectively provided at one sides of the first protruding body and the second protruding body. In a state in which the terminal cap assembly is coupled to the first terminal portion and the second terminal portion, the first connection portion may be disposed between the first seating body and the first terminal portion, and the second connection portion may be disposed between the second seating body and the second terminal portion.

The fuse wire may further include a connector connecting the first connection portion and the second connection portion to each other, and at least a portion of the connector may be inserted into the connection cover, and may not be externally exposed.

The battery module may further include a first cover support portion and a second cover support portion protruding from edges of the first and second terminal portions, the first cover support portion and the second cover support portion forming a seating space in which the terminal cap assembly is to be mounted. The terminal cap assembly may be mounted in the seating space to cover the first electrode terminal of the first terminal portion and the first electrode terminal of the second terminal portion.

The first terminal cover and the second terminal cover may respectively include a first cover body and a second cover body disposed to respectively oppose the first terminal portion and the second terminal portion in the first direction, and a first support body and a second support body respectively extending from one sides of the first cover body and the second cover body in the first direction, the first support body and the second support body respectively opposing the first terminal portion and the second terminal portion in a second direction, perpendicular to the first direction.

According to another aspect of the present disclosure, there is provided a battery module including a plurality of sub-modules including a first sub-module and a second sub-module respectively including a plurality of battery cells stacked in a first direction, a first terminal portion electrically connected to the plurality of battery cells of the first sub-module, the first terminal portion including a plurality of electrode terminals, a second terminal portion electrically connected to the plurality of battery cells of the second sub-module, the second terminal portion including a plurality of electrode terminals, a terminal cap assembly electrically connecting one electrode terminal, among the plurality of electrode terminals of the first terminal portion and one electrode terminal, among the plurality of electrode terminals of the second terminal portion, to each other, the terminal cap assembly covering the one electrode terminal of the first terminal portion and the one terminal of the second terminal portion together, and a plurality of cap covers independently covering remaining electrode terminals, among the plurality of electrode terminals of the first terminal portion, and remaining electrode terminals, among the plurality of electrode terminals of the second terminal portion, respectively. The terminal cap assembly may be disposed at one sides of the plurality of sub-modules in the first direction, and the plurality of cap covers may be disposed at the other sides of the plurality of sub-modules in the first direction.

According to another aspect of the present disclosure, there is provided a terminal cap assembly including a fuse wire electrically connecting a first terminal portion and a second terminal portion, respectively electrically connected to a plurality of different battery cells, to each other, and a protector covering at least a portion of the fuse wire, the first terminal portion, and the second terminal portion, the protector coupled to the first terminal portion and the second terminal portion.

The fuse wire may be provided between the first terminal portion and the second terminal portion to fracture due to a current having a predetermined value or more, and to cut off an electrical connection between the first terminal portion and the second terminal portion.

The fuse wire may include a first connection portion and a second connection portion respectively in contact with the first terminal portion and the second terminal portion, and a connector electrically connecting the first connection portion and the second connection portion to each other.

The protector may include a first terminal cover and a second terminal cover respectively covering the first terminal portion and the second terminal portion, and a connection cover disposed between the first terminal cover and the second terminal cover, the connection cover surrounding the connector.

The first terminal cover and the second terminal cover may respectively include a first protruding body and a second protruding body respectively passing through the first connection portion and second connection portion, the first protruding body and the second protruding body respectively inserted into through-holes of the first terminal portion and the second terminal portion.

Configurations according to the aspects of the present disclosure have been described above, but the configurations are exemplary. Even when other configurations, not set forth herein, are added, it should be understood that the other configurations are within the scope of the present disclosure.

According to an embodiment of the present disclosure, a terminal cap assembly and a battery module including the same may cut off an electrical connection between a plurality of sub-modules when an overcurrent occurs, thereby ensuring safety.

The terminal cap assembly and the battery module including the same may be fixed to terminals of two adjacent sub-modules to fix the two adjacent sub-modules.

The terminal cap assembly and the battery module including the same may minimize the influence of various environmental factors that may hinder safety during transportation, thereby improving safety.

### BRIEF DESCRIPTION OF DRAWINGS

Certain aspects, features, and advantages of the present disclosure are illustrated by the following detailed description with reference to the accompanying drawings.

FIG. 1 is a perspective view of a battery module according to an embodiment of the present disclosure.

FIG. 2 is an exploded perspective view of a battery module according to an embodiment of the present disclosure.

FIG. 3 is an exploded perspective view of a first sub-module and a second sub-module.

FIG. 4 is an enlarged view of portion “A” of FIG. 1.

FIG. 5 is a view of FIG. 4 from which a terminal cap assembly is removed.

FIG. 6 is a perspective view of a terminal cap assembly according to an embodiment of the present disclosure.

FIG. 7 is a view of FIG. 6 in a different direction.

FIG. 8 is a bottom view of a terminal cap assembly according to an embodiment.

FIG. 9 is a side view of a terminal cap assembly according to an embodiment.

### DETAILED DESCRIPTION

Before describing embodiments of the present disclosure, the words and terminologies used in the specification and claims should not be construed with common or dictionary meanings, but construed as meanings and conception coinciding the spirit of the present disclosure under a principle that the inventor(s) may appropriately define the conception of the terminologies to explain the present disclosure in the optimum method.

The same reference numerals in the drawings refer to components or elements performing substantially the same function. For ease of description and understanding, the same reference numerals may be used in different embodiments.

As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof.

In addition, the terms “upper side,” “upper portion,” lower side, ““lower portion,” “side surface,” “front surface,” “rear surface” and the like are described based on a direction illustrated the drawings, and may be described differently when a direction of a corresponding object is changed.

In addition, as used herein, terms including an ordinal number such as “first” and “second” may be used to distinguish between components. The ordinal number is used to distinguish the same or similar components from each other, and the meaning of the term should not be limitedly interpreted due to the use of the ordinal number. For example, components combined with the ordinal number should not be construed as limiting the order of use or arrangement by the number. If necessary, respective ordinal numbers may be used interchangeably.

Hereinafter, the present disclosure will be described in detail with reference to the accompanying drawings. However, embodiments are merely exemplary, and the present disclosure is not limited to specific embodiments.

A battery module 10, on which a terminal cap assembly 50 is mounted, of the present disclosure will be described first.

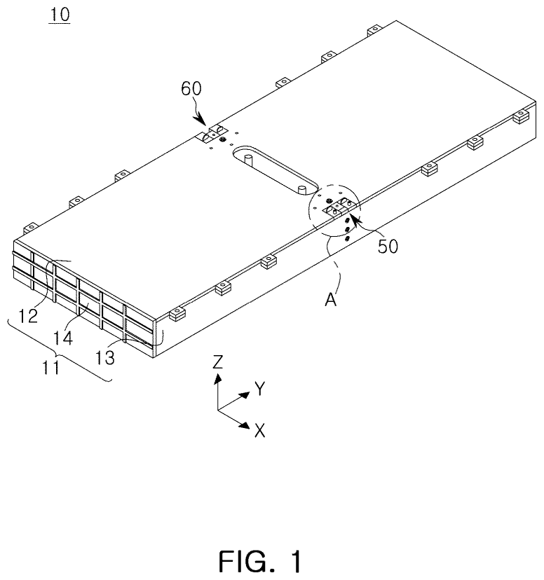

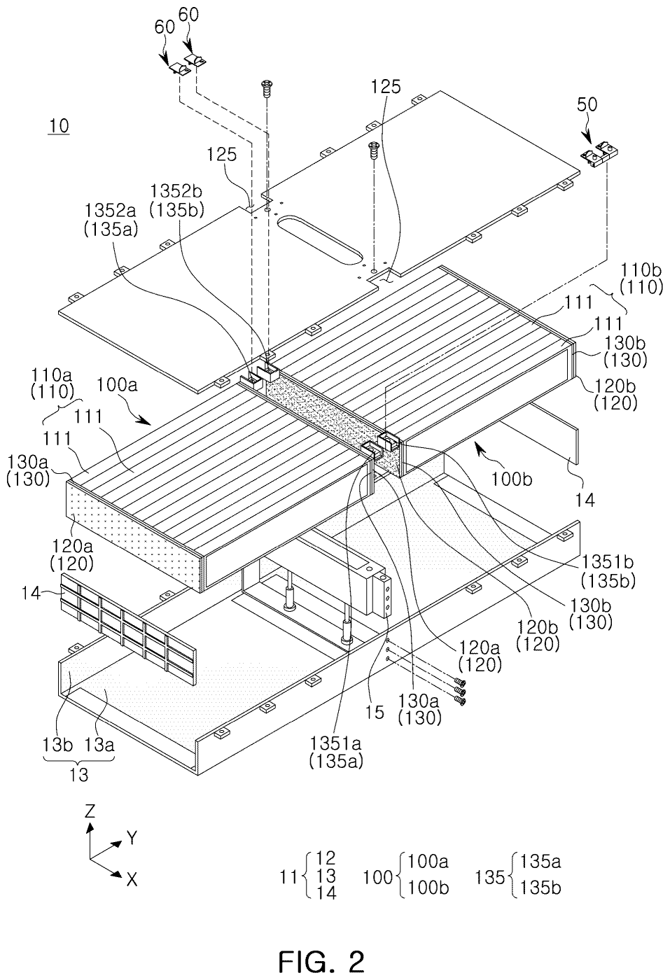

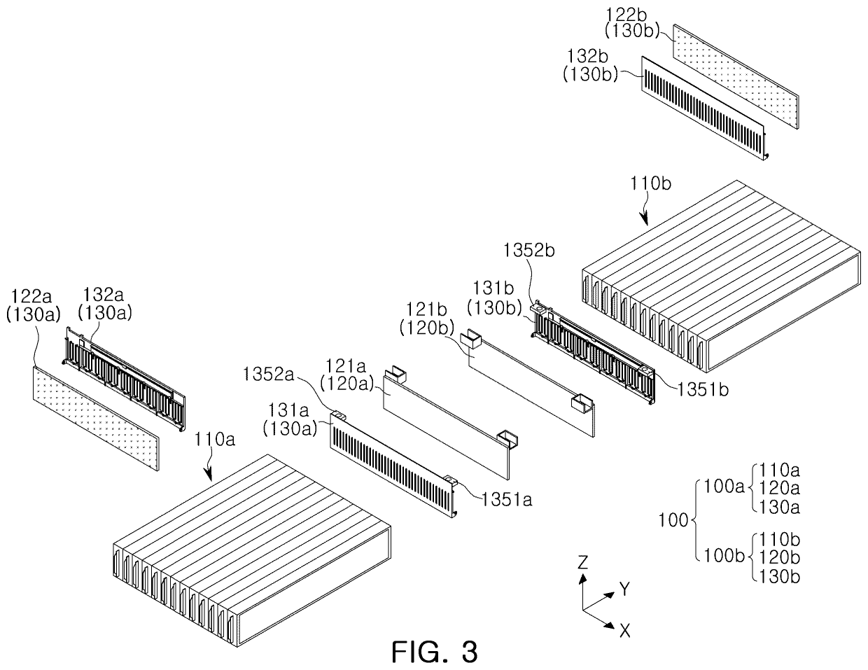

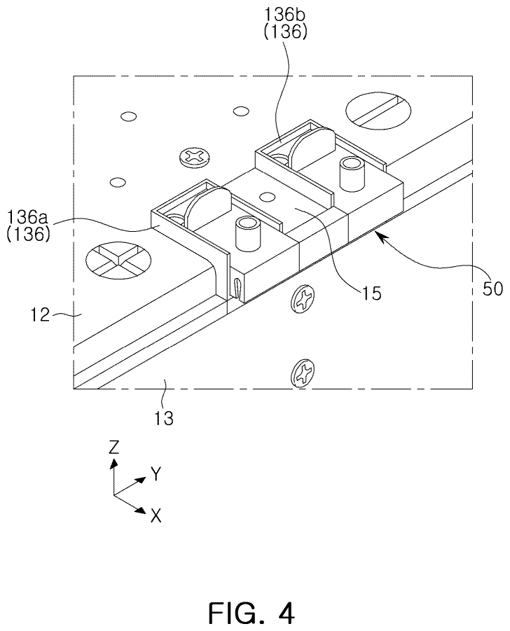

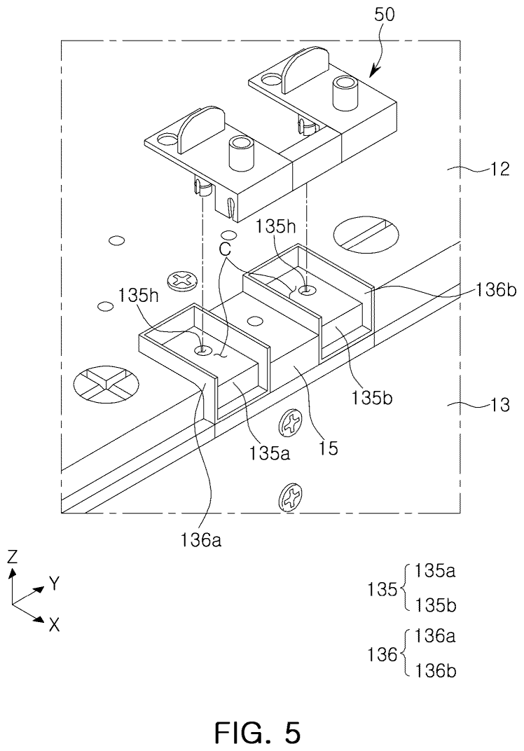

FIG. 1 is a perspective view of a battery module according to an embodiment of the present disclosure. FIG. 2 is an exploded perspective view of a battery module according to an embodiment of the present disclosure. FIG. 3 is an exploded perspective view of a first sub-module and a second sub-module. FIG. 4 is an enlarged view of portion “A” of FIG. 1. FIG. 5 is a view of FIG. 4 from which a terminal cap assembly is removed.

Referring to FIGS. 1 to 5 together, the battery module 10 of the present disclosure may include a sub-module 100 including a first sub-module 100a and a second sub-module 100b respectively including a plurality of battery cells 111. The sub-module 100 may be accommodated in a module case 11 forming the exterior of the battery module 10.

The module case 11 may include a first plate 12 (an upper cover) disposed above the sub-module 100 to cover an upper portion of the sub-module 100, a second plate 13 including a lower cover 13a supporting a lower portion of the sub-module 100, and a side cover 13b disposed on a side of the sub-module 100 to be parallel to the plurality of battery cells 111, and an end plate 14 disposed on both sides of the sub-module 100 in a direction, opposing the first sub-module 100a and the second sub-module 100b.

A center plate 15 may be disposed between the first sub-module 100a and the second sub-module 100b to support two adjacent sub-modules 100.

The upper cover 12 may have a terminal hole 125 to expose a terminal portion 135 of the sub-module 100 to be described below. The terminal portion 135 may be exposed to the outside of the module case 11 through the terminal hole 125, and thus a terminal cap assembly 50 to be described below may be mounted on the terminal portion 135 (see FIGS. 4 and 5).

A plurality of sub-modules 100 may include a cell assembly 110 formed by stacking the plurality of battery cells 111, an insulating cover 120 disposed to oppose the end plate 14, and a busbar assembly 130 electrically connected to the plurality of battery cells 111.

The cell assembly 110 may include the plurality of battery cells 111 stacked to be parallel to each other in a predetermined direction. A direction in which the plurality of battery cells 111 are stacked and a direction in which the sub-modules 100 are disposed may be perpendicular to each other.

The plurality of battery cells 111 may convert chemical energy into electrical energy and supply power to an external circuit, or may receive power externally and convert electrical energy into chemical energy to store electricity. For example, the battery cell 111 may include a nickel metal hydride (Ni-MH) battery or a lithium ion (Li-ion) battery capable of being charged and discharged.

Each of the plurality of battery cells 1000 may accommodate an electrode assembly (not illustrated) formed by stacking a cathode plate and an anode plate. In the electrode assembly, the cathode plate and the anode plate may be stacked with a separator interposed therebetween in a state in which wide surfaces of the cathode plate and the anode plate oppose each other. The separator may prevent an electrical short-circuit between the cathode plate and the anode plate, and may generate a flow of ions. For example, the separator may include a porous polymer film or a porous nonwoven fabric.

In addition, the electrode assembly may be a jelly-roll type electrode assembly formed by winding the cathode plate, the anode plate, and the separator in a predetermined direction, and various-types of electrode assemblies, such as a stacking type electrode assembly, a Z-folding type electrode assembly, and a stack-folding type electrode assembly, may be accommodated in a case.

The plurality of battery cells 111 may be a pouch-type secondary battery, a prismatic-type secondary battery, or a cylindrical-type secondary battery depending on a structure of the case.

The insulating cover 120 may include an electrically insulating material to prevent a short-circuit between the cell assembly 110 and the end plate 14.

The busbar assembly 130 may include a busbar electrically connecting the plurality of battery cells 111 to each other, and a support frame (not illustrated) supporting the busbar. In addition, the busbar assembly 130 may be formed such that the terminal portion 135 is disposed to be close to an adjacent sub-module 100. That is, the busbar may electrically connect the plurality of battery cells 111 and the terminal portion 135 to each other, and the terminal portion 135 may be electrically connected to an external power source.

The first sub-module 100a and the second sub-module 100b may include cell assemblies (a first cell assembly 110a and a second cell assembly 110b), insulating covers 120a and 120b, busbar assemblies 130a and 130b, and terminal portions (a first terminal portion 135a and a second terminal portion 135b).

The busbar assemblies 130a and 130b of the first sub-module and the second sub-module 100a and 100b may include first busbar assemblies 131a and 131b disposed at one sides of the cell assemblies 110a and 110b to oppose the center plate 15, and second busbar assemblies 132a and 132b disposed at the other sides of the cell assemblies 110a and 110b to oppose the end plate 14.

The terminal portions 135a and 135b may be disposed to be close to a plurality of sub-modules 100a and 100b. For example, the terminal portions 135a and 135b may be provided in the first bus bar assemblies 131a and 131b.

A terminal portion (first terminal portion) 135a of the first sub-module 100a and a terminal portion (second terminal portion) 135b of the second sub-module 100b may be spaced apart from each other in a direction (X-axis direction) in which the cell assemblies 100a and 100b are stacked, and may respectively one or more electrode terminals.

For example, the one or more electrode terminals may respectively include first electrode terminals 1351a and 1351b disposed to close to one sides thereof in the direction (X-axis direction) in which the cell assemblies 100a and 100b are stacked, and second electrode terminals 1352a and 1352b disposed to close to the other sides thereof in the direction (X-axis direction) in which the cell assemblies 100a and 100b are stacked.

A first electrode terminal 1351a of the first terminal portion 135a and a first electrode terminal 1351b of the second terminal portion 135b may be disposed to oppose each other in a direction (Y-axis direction) in which the sub-modules 100 are arranged, and a second electrode terminal 1352a of the first terminal portion 135a and a second electrode terminal 1352b of the second terminal portion 135b may be disposed to oppose each other in the direction (Y-axis direction) in which the sub-modules 100 are arranged.

In addition, the first electrode terminals 1351a and 1351b and the second electrode terminals 1352a and 1352b of the terminal portion 135 may have opposite electrical polarities. Electrical polarities of the first electrode terminal 1351a and the second electrode terminal 1352a of the first terminal portion 135a may be opposite to electrical polarities of the first electrode terminal 1351b and the second electrode terminal 1352b of the second terminal portion 135b, respectively. For example, the first electrode terminal 1351a of the first terminal portion 135a and the second electrode terminal 1352b of the second terminal portion 135b may be cathodes, and the second electrode terminal 1352a of the first terminal portion 135a and the first electrode terminal 1351b of the second terminal portion 135b may be anodes.

The insulating covers 120a and 120b of the first sub-module and the second sub-module 100a and 100b may include first insulating covers 121a and 121b disposed between the cell assemblies 110a and 110b and the center plate 15, and second insulating covers 122a and 122b disposed between the cell assemblies 110a and 110b and the end plate 14, respectively. The first insulating covers 121a and 121b may prevent a short-circuit between the first bus bar assemblies 131a and 131b and the center plate 15, and the second insulating covers 122a and 122b may prevent a short-circuit between the second bus bar assemblies 132a and 132b and the end plate 14. In addition, the first insulating covers 121a and 121b may include a cover support portion 136 (to be described below) protruding to surround the terminal portion 135.

In the present disclosure, among the plurality of sub-modules 100, the first sub-module 100a and the second sub-module 100b may be disposed to be symmetrical to each other with respect to the center plate 15, and may have the same configuration.

Accordingly, as described above, for ease, a configuration of the first sub-module 100a may be referred to as a first configuration, and a configuration of the second sub-module 100b may be referred to as a second configuration. For example, among the terminal portions 135, the terminal portion 135a of the first sub-module 100a may be referred to as the first terminal portion 135a, and the terminal portion 135b of the second sub-module 100b may be referred to as the second terminal portion 135b.

In addition, as described above, even with the same configuration, reference numeral “˜a” may refer to a configuration of the first sub-module 100a, and reference numeral “˜b” may refer to a configuration of the second sub-module. For example, the first electrode terminal 1351a may refer to a configuration of the first terminal portion 135a, and the first electrode terminal 1351b may refer to a configuration of the second terminal portion 135b.

The first terminal portion 135a and the second terminal portion 135b may oppose each other with the center plate 15 interposed therebetween. That is, the terminal portions 135 of the plurality of sub-modules 100 may be disposed to be close to each other, not on the outside of the battery module 10. Referring to FIGS. 4 and 5, the terminal cap assembly 50 may be mounted on the terminal portion 135 exposed through the terminal hole 125.

In embodiments of the present disclosure, the busbar assembly 130 may further include the cover support portion 136 protruding along a periphery of the terminal portion 135 to form a seating space C (see FIG. 4). At least a portion of the cap assembly 50 may be seated in the seating space C, such that the cap assembly 50 may be mounted on the battery module 10.

Specifically, the cover support portion 136 may be formed of an electrically insulating material to prevent the terminal portion 135 from being connected to an external conductor material. The cover support portion 136 may protrude upwardly from an edge of the terminal portion 135 to form the seating space C. At least a portion of the terminal cap assembly 50 may be accommodated in the seating space C formed by the cover support portion 136, such that the terminal cap assembly 50 may be stably mounted on the terminal portion 135.

As described above, the cover support portion 136 may include a first cover support portion 136a provided in the first terminal portion 135a, and a second cover support portion 136b provided in the second terminal portion 135b.

In addition, for ease, the seating space C, formed by the first cover support portion 136a, may be referred to as a first seating space, and the seating space C, formed by the second cover support portion 136b, may be referred to as a second seating space.

In an embodiment of the present disclosure, during transportation of the battery module 10, conductive particles may be likely to come into contact with the terminal portion 135, externally exposed through the terminal hole 125, to cause a short-circuit. Accordingly, the terminal cap assembly 50 and the cap cover 60 to be described below may cover the terminal portion 135 to prevent a short-circuit.

An overcurrent may occur due to impacts, internal defects, or the like of at least one of the plurality of sub-modules 100 (for example, at least one of the first sub-module 100a and the second sub-module 100b).

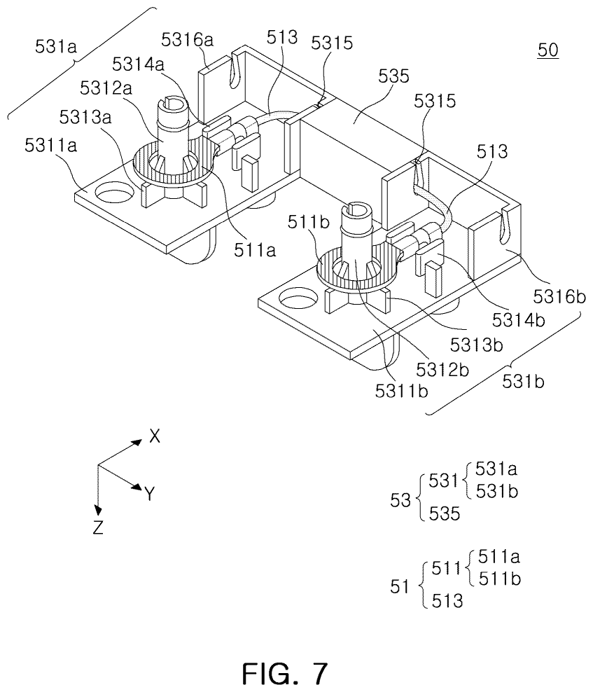

Accordingly, the terminal cap assembly 50 of the present disclosure may include a protector 53 fixed to the terminal portion 135 to cover the terminal portion 135, and a fuse wire 51 provided in the protector 53 to electrically connect adjacent terminal portions 135a and 135b to each other, the fuse wire 51 provided to fracture when a predetermined current (for example, an overcurrent having a predetermined value or more) flows (see FIG. 7). That is, the terminal cap assembly 50 may electrically connect the plurality of sub-modules 100 to each other through the fuse wire 51. The cap cover 60 may independently cover the electrode terminals 1351 and 1352 of the terminal portion 135 regardless of an electrical connection relationship.

According to an embodiment, the first sub-module 100a and the second sub-module 100b may be electrically connected to each other by one terminal cap assembly 50 disposed on one of the first electrode terminals 1351a and 1351b and the second electrode terminals 1352a and 1352b, and the cap cover 60 may be disposed on remaining electrode terminals 1351 and 1352. For example, the terminal cap assembly 50 may electrically connect the first electrode terminal 1351a of the first terminal portion 135a and the first electrode terminal 1351b of the second terminal portion 135b to each other while covering the first electrode terminal 1351a of the first terminal portion 135a and the first electrode terminal 1351b of the second terminal portion 135b. In addition, the cap cover 60 may be independently disposed on remaining electrode terminals 1352a and 1352b to cover the remaining electrode terminals 1352a and 1352b.

That is, one of the first terminal portion 135a and the second terminal portion 135b may be covered by the terminal cap assembly 50, and the first terminal portion 135a and the second terminal portion 135b may be electrically connected to each other, and a remaining terminal portion may be independently covered by the cap cover 60.

The cap cover 60 may be inserted into the seating space C of the cover support portion 136 to cover the terminal portion 135.

Specifically, in at least one of embodiments of the present disclosure, the battery module of the present disclosure may include a plurality of sub-modules 1000 (a first sub-module 100a and a second sub-module 100b), a first terminal portion 135a and a second terminal portion 135b provided in the first sub-module 100a and the second sub-module 100b, and a terminal cap assembly 50 electrically connecting the first terminal portion 135a and the second terminal portion 135b to each other, the terminal cap assembly 50 covering at least a portion of the first terminal portion 135a and the second terminal portion 135b such that the at least a portion is not externally exposed. Here, the terminal cap assembly 50 may be detachably coupled to the first terminal portion 135a and the second terminal portion 135b while covering the fuse wire 51 electrically connecting the first terminal portion 135a and the second terminal portion 135b to each other, and at least one of the first terminal portion 135a or the second terminal portion 135b such that the fuse wire 51 and the at least one of the first terminal portion 135a or the second terminal portion 135b are not externally exposed.

Hereinafter, the terminal cap assembly 50 of the present disclosure will be described in detail with reference to the drawings.

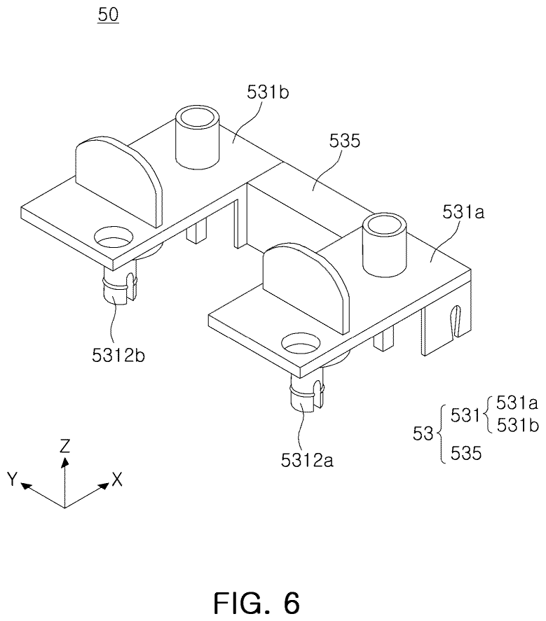

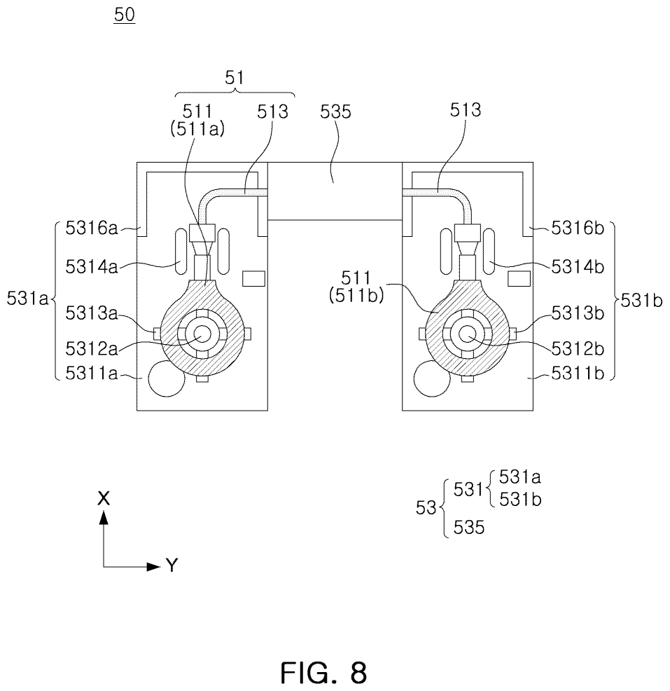

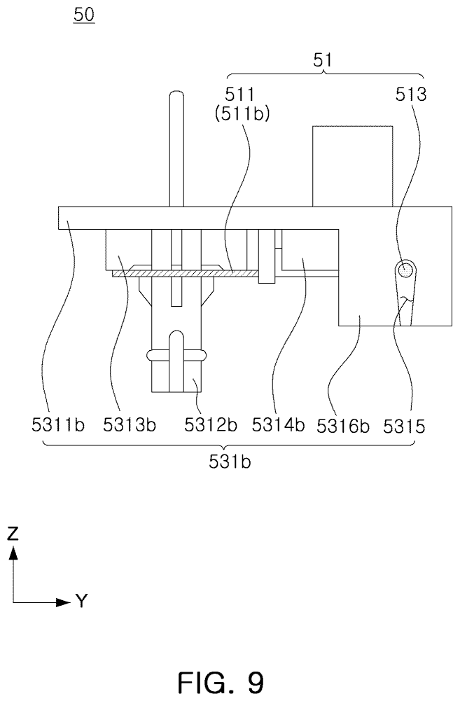

FIG. 6 is a perspective view of a terminal cap assembly according to an embodiment of the present disclosure. FIG. 7 is a view of FIG. 6 in a different direction. FIG. 8 is a bottom view of a terminal cap assembly according to an embodiment. FIG. 9 is a side view of a terminal cap assembly according to an embodiment.

Referring to FIGS. 6 to 9 together, the terminal cap assembly 50 of the present disclosure may include a fuse wire 51 electrically connecting terminal portions 135 of a plurality of adjacent sub-modules 100 to each other, and a protector 53 covering the fuse wire 51 and the terminal portion 135.

The fuse wire 51 may electrically connect the terminal portions 135 of the adjacent sub-modules 100 to each other, and may fracture itself when a predetermined current flows. For example, the fuse wire 51 may fracture when a predetermined current flows due to a small thickness thereof.

Specifically, the fuse wire 51 may have a predetermined diameter, enabling the fuse wire 51 to be melted by heat caused by an overcurrent and to rapidly fracture within one second. For example, the fuse wire 51 may have a diameter of 25 mm² to 1.00 mm², such that the fuse wire 51 may fracture within one second due to a predetermined overcurrent.

However, the above-described diameter of the fuse wire 51 is only an example, and it may be understood that any diameter of the fuse wire 51, enabling the fuse wire 51 to fracture itself when an overcurrent flows and to cut off an electrical connection between the sub-modules 100, is within the scope of the present disclosure. For example, the fuse wire 51 may be provided as a plurality of wires having different diameters, and the plurality of wires may be provided to fracture according to a degree of overcurrent.

That is, at least a portion the fuse wire 51 of the present disclosure may be surrounded by the protector 53, and thus may electrically connect the first terminal portion 135a and the second terminal portion 135b to each other.

The fuse wire 51 may include a connection portion 511 in contact with and electrically connected to a plurality of terminal portions 135, and a connector 513 connecting a plurality of connection portions 511 to each other, the connector 513 that may be covered by the protector 53.

The connection portion 511 may include a first connection portion 511 in contact with the first terminal portion 135a, and a second connection portion 135b in contact with the second terminal portion 135b, and the first connection portion 511 and the second connection portion 135b may have through-holes, such that protruding bodies 5312a and 5312b of the protector 53 to be described below may be inserted into the through-holes. In addition, the first connection portion 511a and the second connection portion 511b may be inserted into fixing bodies 5314a and 5314b, respectively, and fixed to the protector 53.

As described above, the connector 513 may have a diameter, enabling the connector 513 to fracture when an overcurrent flows. However, the present disclosure is not limited thereto, and the connection portion 511 may also fracture.

The protector 53 may include a plurality of terminal covers 531 covering a plurality of adjacent terminal portions 135, and a connection cover 535 connecting the plurality of terminal covers 531. The protector 53 may cover the terminal portion 135 as well as the fuse wire 51 such that the terminal portion 135 as well as the fuse wire 51 are not externally exposed.

Specifically, the terminal cap assembly 50 may include a terminal cover 531 covering terminal portions 135 of different sub-modules 100, and a connection cover 535 disposed between the terminal portions 135, the connection cover 535 surrounding the connector 513 of the fuse wire 51.

The terminal cover 531 may include a first terminal cover 531a covering one of electrode terminals of the first terminal portion 135a, and a second terminal cover 531b covering one of electrode terminals of the second terminal portion 135b.

For example, the first terminal cover 531a may include a first cover body 5311a covering a first electrode terminal 1351a of the first terminal portion 135a, and a first protruding body 5312a protruding from the first cover body 5311a, the first protruding body 5312a inserted into a terminal hole h of the first terminal portion 135a. In addition, the first terminal cover 531a may include a first seating body 5313a supporting the first connection portion 511a of the fuse wire 51 in the first protruding body 5312a, a first fixing body 5314a fixing the first connection portion 511a, and a first support body 5316a having a wire hole 5315 through which the fuse wire 51 passes.

For example, the second terminal cover 531b may include a second cover body 5311b covering a first electrode terminal 1351b of the second terminal portion 135b, and a second protruding body 5312b protruding from the second cover body 5311b, the second protruding body 5312b inserted into a terminal hole h of the second terminal portion 135b. In addition, the second terminal cover 531b may include a second seating body 5313b supporting the second connection portion 511b of the fuse wire 51 in the second protruding body 5312b, a second fixing body 5314b fixing the second connection portion 511b, and a second support body 5316b having a wire hole 5315 through which the fuse wire 51 passes.

Respective configurations of the first terminal cover 531a and the second terminal cover 531b described above may be only different from each other in that the first terminal cover 531a and the second terminal cover 531b are disposed on different terminals 135, and may be the same configuration. Accordingly, the respective configurations of the first terminal cover 531a and the second terminal cover 531b will be described together.

Cover bodies 5311a and 5311b and support bodies 5316a and 5316b may cover a seating space C such that the terminal portions 135a and 135b are not externally exposed (see FIGS. 4 and 5). That is, the terminal portions 135a and 135b may be covered by cover support portions 136a and 136b, the cover bodies 5311a and 5311b, and the support bodies 5316a and 5316b not to be externally exposed.

The protruding bodies 5312a and 5312b may protrude from the cover bodies 5311a and 5311b in a predetermined direction (for example, a direction toward a step portion 135). At least portions of the protruding bodies 5312a and 5312b may be inserted into and fixed to the through-holes 135h of the terminal portions 135a and 135b, respectively. In addition, as described above, the protruding bodies 5312a and 5312b may pass through the through-holes of the connection portions 511a and 511b together.

That is, the protruding bodies 5312a and 5312b may sequentially pass through the through-holes of the connection portions 511a and 511b and the through-holes 135b of the terminal portions 135a and 135b, and may be fixed to the adjacent sub-modules 100a and 100b.

Referring to FIG. 7, seating bodies 5313a and 5313b may be formed at one sides of the protruding bodies 5312a and 5312b, such that the connection portions 511a and 511b may be seated on the terminal portions 135a and 135b. Accordingly, the protruding bodies 5312a and 5312b may pass through the connection portions 511a and 511b, such that the connection portions 511a and 511b may be stably disposed between the seating bodies 5313a and 5313b and the terminal portions 135a and 135b.

In addition, the cover bodies 5311a and 5311b may oppose the terminal portions 135a and 135b in a first direction (a Z-axis direction in the drawings), and the support bodies 5316a and 5316b may extend in the first direction from one sides of the cover bodies 5311a and 5311b, and may oppose the terminal portions 135a and 135b in a direction (a Y-axis direction in the drawings), perpendicular to the first direction.

Such a structure may allow the terminal portions 135a and 135b not to be externally exposed by the cover portions 136a and 136b, the cover bodies 5311a and 5311b, and the support bodies 5316a and 5316b.

The seating bodies 5313a and 5313b may support the connection portions 511a and 511b to be in close contact with the terminal portions 135a and 135b in a state in which the terminal cap assembly 50 is mounted on the terminal portions 135a and 135b. Accordingly, even when vibrations or impacts that may occur during transportation of the battery module 10 are applied, a state in which the connection portions 511a and 511b are in contact with the terminal portions 135a and 135b may be maintained.

The fixing bodies 5314a and 5314b may fix the fuse wire 51 to predetermined positions in the cover bodies 5311a and 5311b.

The connection cover 535 may accommodate the fuse wire 51 such that the fuse wire 51 is not externally exposed, and may connect the first terminal cover 531a and the second terminal cover 531b to each other. The connection cover 535 may surround at least a portion of the connector 513 to prevent the connector 513 from being in contact with an adjacent member, such as a module case 11.

As described, referring to FIGS. 4 and 5 together, the terminal portions 135a and 135b may be electrically connected to each other by the fuse wire 51, and may not be externally exposed by the protector 53.

Accordingly, the terminal cap assembly 50 of the present disclosure may cut off an electrical connection between the plurality of sub-modules 100 when an overcurrent of the plurality of sub-modules 100 occurs, and may cover the terminal portion 135 such that the terminal portion 135 is not externally exposed. In addition, the terminal cap assembly 50 of the present disclosure may minimize degradation in durability of the fuse wire 51 due to vibrations or impacts occurring during transportation through structures of the connection cover 535 and the terminal covers 531a and 531b.

According to another embodiment of the present disclosure, the terminal cap assembly of the present disclosure may be provided as a plurality of terminal cap assemblies 50 in the battery module 10. For example, in FIG. 2, it is illustrated that one terminal cap assembly 50 is provided and disposed only at one side of the battery module 10, but two terminal cap assemblies 50 may be provided and disposed on both sides of the battery module 10 depending on an electrical connection relationship between the sub-modules 100.

That is, when the above-described terminal cap assembly 50 is provided as at least one terminal cap assembly 50, it may be understood that both one terminal cap assembly 50 and two terminal cap assemblies 50 are within the scope of the present disclosure.

In addition, the terminal cap assembly 50 may be provided to be detachable from the terminal portion 135.

After stable transportation through the terminal cap assembly 50 is completed, an operator may remove the terminal cap assembly 50 and connect various electric devices such as electric vehicles and the like to the terminal portion 135.

Only specific examples of implementations of certain embodiments are described. Variations, improvements and enhancements of the disclosed embodiments and other embodiments may be made based on the disclosure of this patent document.

The features described above are merely examples of the application of the principles of the present disclosure, and other components may be included without departing from the scope of the present disclosure.

What is claimed is:

1. A battery module comprising:
a plurality of sub-modules including a first sub-module and a second sub-module including a plurality of battery cells, respectively;
a first terminal portion electrically connected to the plurality of battery cells of the first sub-module, the first terminal portion including one or more electrode terminals including a first electrode terminal;
a second terminal portion electrically connected to the plurality of battery cells of the second module, the second terminal portion including one or more electrode terminals including a first electrode terminal; and
a terminal cap assembly covering the first terminal portion and the second terminal portion, the terminal cap assembly electrically connecting the first terminal portion and the second terminal portion to each other,
wherein the terminal cap assembly includes:
a fuse wire electrically connecting the first electrode terminal of the first terminal and the first electrode terminal of the second terminal to each other; and
a protector covering the fuse wire, the first electrode terminal of the first terminal, and the first electrode terminal of the second terminal.

2. The battery module of claim 1, further includes a cap cover covering the electrode terminal that is not covered by the terminal cap assembly,
wherein the plurality of battery cells are stacked in a first direction.

3. The battery module of claim 2, wherein
the first terminal portion further includes a second electrode terminal spaced apart from the first electrode terminal of the first terminal portion in the first direction, and the second terminal portion further includes a second electrode terminal spaced apart from the first electrode terminal of the second terminal portion in the first direction, and
the cap cover independently covers the second electrode terminal of the first terminal portion and the second electrode terminal of the second terminal portion.

4. The battery module of claim 3, wherein
the first electrode terminal of the first terminal portion and the second electrode terminal of the second terminal portion have different electrical polarities, and
a terminal cap assembly is disposed at one sides of the plurality of sub-modules in the first direction, and a cap cover is disposed at the other sides of the plurality of sub-modules in the first direction.

5. The battery module of claim 3, wherein
the terminal cap assembly is provided as one terminal cap assembly and connected to the first electrode terminal of the first terminal portion and the second electrode terminal of the second terminal portion, and
the terminal cap is provided as two terminal caps, and the two terminal caps are disposed on the second electrode terminal of the first terminal portion and the second electrode terminal of the second terminal portion, respectively.

6. The battery module of claim 1, wherein the fuse wire is provided to fracture due to a current having a predetermined value or more, and to cut off an electrical connection between the first terminal portion and the second terminal portion.

7. The battery module of claim 6, wherein the fuse wire has a diameter of 0.25 mm² to 1 mm².

8. The battery module of claim 1, wherein the protector includes:
a first terminal cover covering the first electrode terminal of the first terminal portion;
a second terminal cover covering the first electrode terminal of the second terminal portion; and
a connection cover connecting the first terminal cover and the second terminal cover to each other.

9. The battery module of claim 8, wherein
the electrode terminal of the first terminal portion and the electrode terminal of the second terminal portion has terminal holes, respectively, and
the first terminal cover and the second terminal cover include a first protruding body and a second protruding body protruding to be inserted into the terminal holes, respectively.

10. The battery module of claim 9, wherein
the fuse wire includes a first connection portion and a second connection portion in contact with and electrically connected to the first electrode terminal of the first terminal portion and the first electrode terminal of the second terminal portion, respectively, and
the first protruding body and the second protruding body pass through the first connection portion and the second connection portion, and are inserted into the first electrode terminal of the first terminal portion and the first electrode terminal of the second terminal portion, respectively.

11. The battery module of claim 10, wherein
the protector includes a first seating body and a second seating body respectively provided at one sides of the first protruding body and the second protruding body, and
in a state in which the terminal cap assembly is coupled to the first terminal portion and the second terminal portion, the first connection portion is disposed between the first seating body and the first terminal portion, and the second connection portion is disposed between the second seating body and the second terminal portion.

12. The battery module of claim 11, wherein the fuse wire further includes a connector connecting the first connection portion and the second connection portion to each other, and at least a portion of the connector is inserted into the connection cover and is not externally exposed.

13. The battery module of claim 9, further comprising:
a first cover support portion and a second cover support portion protruding from edges of the first and second terminal portions, the first cover support portion and the second cover support portion forming a seating space in which the terminal cap assembly is to be mounted,
wherein the terminal cap assembly is mounted in the seating space to cover the first electrode terminal of the first terminal portion and the first electrode terminal of the second terminal portion.

14. The battery module of claim 13, wherein the first terminal cover and the second terminal cover respectively include:
a first cover body and a second cover body disposed to respectively oppose the first terminal portion and the second terminal portion in the first direction; and
a first support body and a second support body respectively extending from one sides of the first cover body and the second cover body in the first direction, the first support body and the second support body respectively opposing the first terminal portion and the second terminal portion in a second direction, perpendicular to the first direction.

15. A battery module comprising:
a plurality of sub-modules including a first sub-module and a second sub-module respectively including a plurality of battery cells stacked in a first direction;
a first terminal portion electrically connected to the plurality of battery cells of the first sub-module, the first terminal portion including a plurality of electrode terminals;
a second terminal portion electrically connected to the plurality of battery cells of the second sub-module, the second terminal portion including a plurality of electrode terminals;
a terminal cap assembly electrically connecting one electrode terminal, among the plurality of electrode terminals of the first terminal portion and one electrode terminal, among the plurality of electrode terminals of the second terminal portion, to each other, the terminal cap assembly covering the one electrode terminal of the first terminal portion and the one terminal of the second terminal portion together; and
a plurality of cap covers independently covering remaining electrode terminals, among the plurality of electrode terminals of the first terminal portion, and remaining electrode terminals, among the plurality of electrode terminals of the second terminal portion, respectively,
wherein the terminal cap assembly is disposed at one side of the first and the second sub-modules in the first direction, and the plurality of cap covers are disposed at the other side of the first and the second sub-modules in the first direction.

16. A terminal cap assembly comprising:
a fuse wire electrically connecting a first terminal portion and a second terminal portion, respectively,; and
a protector covering at least a portion of the fuse wire, the first terminal portion, and the second terminal portion, the protector coupled to the first terminal portion and the second terminal portion.

17. The terminal cap assembly of claim 16, wherein the fuse wire is provided between the first terminal portion and the second terminal portion to fracture due to a current having a predetermined value or more, and to cut off an electrical connection between the first terminal portion and the second terminal portion.

18. The terminal cap assembly of claim 17, wherein the fuse wire includes:
a first connection portion and a second connection portion respectively in contact with the first terminal portion and the second terminal portion; and
a connector electrically connecting the first connection portion and the second connection portion to each other.

19. The terminal cap assembly of claim 18, wherein the protector includes:
a first terminal cover and a second terminal cover respectively covering the first terminal portion and the second terminal portion; and
a connection cover disposed between the first terminal cover and the second terminal cover, the connection cover surrounding the connector.

20. The terminal cap assembly of claim 19, wherein the first terminal cover and the second terminal cover respectively include a first protruding body and a second protruding body respectively passing through the first connection portion and second connection portion, the first protruding body and the second protruding body respectively inserted into through-holes of the first terminal portion and the second terminal portion.
